(19) United States
(12) Patent Application Publication
(10) Pub. No.: US 2004/0061943 A1
(43) Pub. Date: Apr. 1, 2004

(54) Vehicle accessory system

(76) Inventors: John P. Bosch, Scottsdale, AZ (US); Clyde McKay, Scottsdale, AZ (US)

Correspondence Address: STONEMAN LAW OFFICES, LTD, 3113 NORTH 3RD STREET, PHOENIX, AZ, 85012, US

(21) Appl. No.: 10/670,414

(22) Filed: Sep. 24, 2003

Related U.S. Application Data
(60) Provisional application No. 60/414,374, filed on Sep. 26, 2002.

(51) Int. Cl. G02B 5/02; G02B 13/20

(52) U.S. Cl. 359/599

(57) ABSTRACT

A vehicle accessory system for use with a cigarette-lighter-type power socket. More specifically, an illuminated in-vehicle accessory system that reduces the attention demands on a driver by providing clear visual indication of the system's size, shape and location. The described system is a plug-in power adapter consisting of a substantially translucent, internally-illuminated housing.

### CROSS-REFERENCE TO RELATED APPLICATION

The present application is related to prior provisional application Serial No. 60/414,374, filed Sep. 26, 2002, entitled “VEHICLE ACCESSORY SYSTEM”, the contents of which are incorporated herein by this reference and are not admitted to be prior art with respect to the present invention by the mention in this cross-reference section.

### BACKGROUND

This invention relates to providing an improved vehicle accessory system. More specifically, this invention relates to illuminated in-vehicle accessory systems that reduce the attention demands on a driver by providing clear visual indication of the systems' size, shape and location. The year 2000 U.S. Census figures for urban regions reported that Americans are spending longer to commute as the United States transportation system becomes increasingly crowded. Nationally, the average daily time spent commuting increased from 22.4 minutes in 1990 to 25.5 minutes in 2000. The U.S. Census data included estimates of how many additional hours people in the nation's largest urban areas spent commuting in 2000 than in 1990. In some areas, it is as high as 44 hours (the equivalent of an additional working week). The average American spent 26 more hours commuting annually in 2000 than in 1990. Because Americans are spending more time in their automobiles, safety of our highway transportation system has become a critical issue for all motorists.

Many motorists now want in-vehicle information, communication and entertainment systems to make the increased travel hours more productive and/or enjoyable; however, there is growing concern regarding the potential distraction of such systems. Driver distraction has been one of the leading causes of crashes since highway safety reporting by police began decades ago. Responding to changes in the external driving environment should be the driver's priority task; however, a driver may balance this along with such tasks as monitoring the operational status of the automobile, conversations with other passengers, monitoring children, eating, and potentially, the interaction with in-vehicle accessory devices. The problem of driver distraction is amplified at night as the darkened vehicle interior reduces a driver's ability to quickly locate, access and manipulate accessory devices. Therefore, a need exists for in-vehicle accessory systems designed with clear, quickly-identifiable visual indicators to minimize the amount of time drivers take their eyes off the road or a hand off the wheel. Designing systems that limit the amount of unnecessary and excessive attention demands on a driver while he or she is driving would benefit many.

### OBJECTS AND FEATURES OF THE INVENTION

A primary object and feature of the present invention is to provide an in-vehicle accessory system that reduces the attention demands on the vehicle operator by providing a clear visual indication of size, shape and location.

It is a further object and feature of the present invention to provide an illuminated system that reduces the attention demands on the vehicle operator by providing a clear visual indication of size, shape and location in a darkened environment.

It is an additional primary object and feature of the present invention to provide such a system that is efficient, inexpensive and handy. Other objects and features of this invention will become apparent with reference to the following descriptions.

### SUMMARY OF THE INVENTION

In accordance with a preferred embodiment hereof, this invention provides a vehicle accessory system for use with at least one plug-in accessory outlet comprising: translucent housing means for housing a vehicle plug-in accessory for use with the at least one plug-in accessory outlet; illumination means, within such translucent housing means for indicating presence of power; wherein such translucent housing means comprises light diffusion means for diffusing the light of such illumination means along substantially an entire length of such translucent housing means. Moreover, it provides such a vehicle accessory system wherein such system further comprises light blocking means for locally blocking a substantial exit of the light from such translucent housing means. Additionally, it provides such a vehicle accessory system wherein such light blocking means comprises at least one reflecting means for internally reflecting the light from such illumination means and such light diffusion means. Also, it provides such a vehicle accessory system wherein: such light blocking means further comprises aperture means; and such aperture means comprises indicia means illuminated by such illumination means and such light diffusion means. In addition, it provides such a vehicle accessory system wherein such light blocking means further comprises retaining means for retaining at least one accessory cord in at least one stowed position.

In accordance with another preferred embodiment hereof, this invention provides a vehicle accessory system for use with at least one plug-in accessory outlet comprising: at least one translucent housing structured and arranged to house a vehicle plug-in accessory for use with the at least one plug-in accessory outlet; at least one illuminator, within such at least one translucent housing, structured and arranged to indicate presence of power; wherein such at least one translucent housing comprises at least one light diffuser for diffusing the light of such at least one illuminator along substantially an entire length of such at least one translucent housing. And, it provides such a vehicle accessory system wherein such system further comprises at least one light blocker structured and arranged to locally block a substantial exit of the light from such at least one translucent housing. Further, it provides such a vehicle accessory system wherein such at least one illuminator comprises at least one light emitting diode. Even further, it provides such a vehicle accessory system wherein such at least one light blocker comprises aperture portions comprising indicia illuminated by such at least one illuminator and such at least one light diffuser. Moreover, it provides such a vehicle accessory system wherein the shape of such translucent housing means comprises at least one portion of an essentially circular annulus. Additionally, it provides such a vehicle accessory system wherein such at least one light blocker comprises: at least one element attachable with such housing; and at least one reflector structured and arranged to internally reflect the light from such at least one illuminator. Also, it provides such a vehicle accessory system wherein such at least one light blocker further comprises at least one retainer structured and arranged to retain at least one accessory cord in at least one stowed position. In addition, it provides such a vehicle accessory system wherein such at least one translucent housing comprises at least one rigid moldable material. And, it provides such a vehicle accessory system wherein such at least one light diffuser comprises at least one surface texture applied to such at least one translucent housing. Further, it provides such a vehicle accessory system wherein such at least one light diffuser comprises at least one light diffusing compound integrally formed within such at least one translucent housing. Even further, it provides such a vehicle accessory system wherein such at least one light diffuser comprises at least one surface coating applied to such at least one translucent housing. Even further, it provides such a vehicle accessory system wherein such at least one light blocker comprises an essentially opaque outer cover structured and arranged to be attachable with such at least one translucent housing. Even further, it provides such a vehicle accessory system wherein such at least one light blocker comprises an essentially opaque coating applied to such at least one translucent housing. Even further, it provides such a vehicle accessory system wherein such at least one translucent housing comprises at least one portion sufficiently transparent to provide an indication of an internal content of such at least one translucent housing from outside such at least one translucent housing.

In addition, it provides a vehicle accessory system, for providing increased safety for a vehicle driver in low ambient-light conditions, comprising: at least one vehicle comprising at least one plug-in accessory outlet within view of the driver; at least one translucent housing structured and arranged to house a vehicle plug-in accessory for use with said at least one plug-in accessory outlet; and at least one illuminator, within said at least one translucent housing, structured and arranged to indicate presence of power; wherein said at least one translucent housing comprises at least one light diffuser for diffusing the light of said at least one illuminator along substantially an entire length of said at least one translucent housing; wherein said vehicle accessory system, when said at least one plug-in accessory outlet is powering said at least one illuminator, is structured and arranged to provide clear visual indication of the vehicle plug-in accessory's locational presence when in use in low ambient light conditions.

### BRIEF DESCRIPTION OF THE DRAWINGS

FIG. 1 is a perspective view of in-vehicle accessory system according to a preferred embodiment of the present invention.

FIG. 2 is a perspective view of in-vehicle accessory system engaged in a dash-mounted accessory outlet according to a preferred embodiment of the present invention.

FIG. 3 is a perspective view, illustrating the illuminated features of in-vehicle accessory system, according to the preferred embodiment of FIG. 2.

FIG. 4 is a front elevational view of in-vehicle accessory system according to the preferred embodiment of FIG. 1.

FIG. 5 is a rear elevational view of in-vehicle accessory system according to the preferred embodiment of FIG. 1.

FIG. 6 is an exploded view of in-vehicle accessory system according to the preferred embodiment of FIG. 1.

FIG. 7 is the sectional view 7-7 of FIG. 4 according to the preferred embodiment of FIG. 1.

FIG. 8 is a depiction of the circuit board assembly and upper housing of in-vehicle accessory system according to the preferred embodiment of FIG. 1.

FIG. 9 is a perspective view, illustrating the reflective features of the outer opaque cover of in-vehicle accessory system, according to the preferred embodiment of FIG. 1.

### DETAILED DESCRIPTION OF THE BEST MODE AND PREFERRED EMBODIMENTS OF THE INVENTION

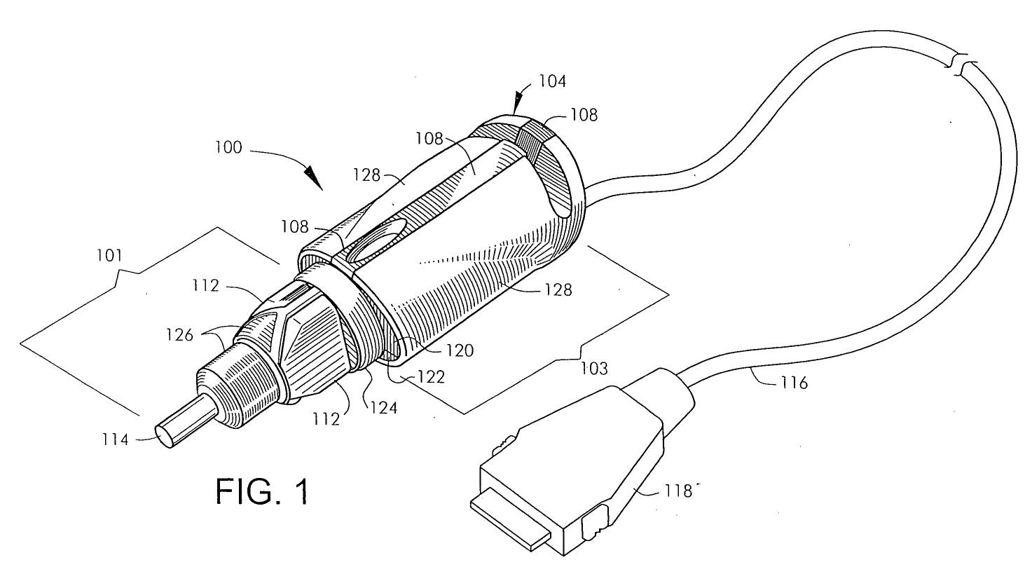

FIG. 1 is a perspective view of in-vehicle accessory system 100 according to a preferred embodiment of the present invention. For the purpose of illustration, the preferred embodiment of FIG. 1 is an adapter used to power or recharge a mobile phone. Upon reading this specification it will be understood by those of skill in the art that under appropriate circumstances, such as advances in technology, user preference, etc., other in-vehicle accessory embodiments that are preferably adapted to be powered by a “plug-in” cigarette-lighter-type accessory power socket, such as power inverters, battery chargers, power cords for electronic devices, etc., may suffice. Further, the term “vehicle” may preferably include any transportation means having this type of accessory power socket, and is not limited to automobiles, boats, and aircraft.

In-vehicle accessory system 100 is preferably composed of two principal portions; a socket-engaging portion 101 for insertion into an accessory power socket, and a graspable portion 103 to assist the user in inserting and removing in-vehicle accessory system 100, as shown. Preferably, in-vehicle accessory system 100 further comprises a multi-part exterior housing 104, comprising opaque cover(s) 128 (herein embodying light-blocking means for locally blocking a substantial exit of the light from such translucent housing means), internally illuminated translucent portions 108 (herein embodying translucent housing means for housing a vehicle plug-in accessory for use with the at least one plug-in accessory outlet), conductive negative ground terminal(s) 112 and spring-loaded conductive positive terminal 114, as shown. Preferably, joined to exterior housing 104 is accessory cord 116 and connector 118, as shown. Preferably, translucent portions 108 further comprise upper housing 120, lower housing 122, retention ring 124 and terminal receiver 126, as shown. Preferably, opaque cover(s) 128 are snap-engaged over upper housing 120 and lower housing 122, as shown (herein embodying an essentially opaque outer cover structured and arranged to be attachable to such at least one translucent housing).

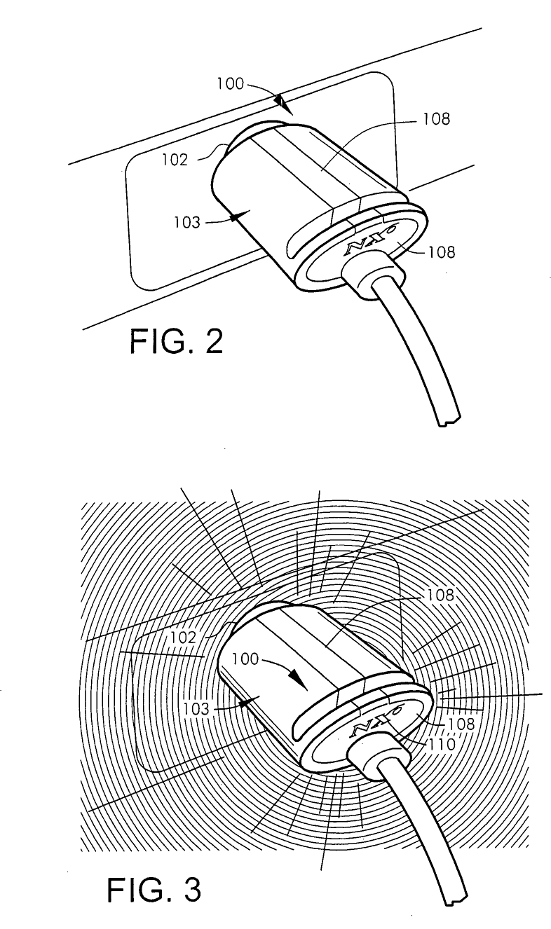

FIG. 2 is a perspective view of in-vehicle accessory system 100 engaged in a dash-mounted accessory power socket 102, according to a preferred embodiment of the present invention. While engaged within accessory power socket 102, graspable portion 103 is preferably exposed to the user for ease of manipulation, as shown. Preferably, when powered by accessory power socket 102, translucent portions 108 are internally illuminated, as shown in FIG. 3.

FIG. 3 is a perspective view, illustrating the illuminated features of in-vehicle accessory system 100, according to the preferred embodiment of FIG. 2. In a low ambient light environment, substantially the entire length of graspable portion 103 is clearly visible to the user by means of the illuminated translucent portions 108, as shown. The use of illuminated external components within in-vehicle accessory system 100 assists the vehicle operator by providing clear visual indication of the size, shape and location of graspable portion 103, as shown. Secondarily, the internally illuminated external components preferably provide a visual indication that in-vehicle accessory system 100 is properly engaged in accessory outlet 102, and that in-vehicle accessory system 100 is powered, as shown. In-vehicle accessory system 100 may preferably include indicia 110 that may be formed as an internally illuminated aperture within opaque cover(s) 128 or, as illustrated, may be an opaque overlay that forms a silhouette when applied to translucent portions 108 (herein embodying wherein such light blocking means further comprises aperture means; and such aperture means comprises indicia means illuminated by such illumination means and such light diffusion means).

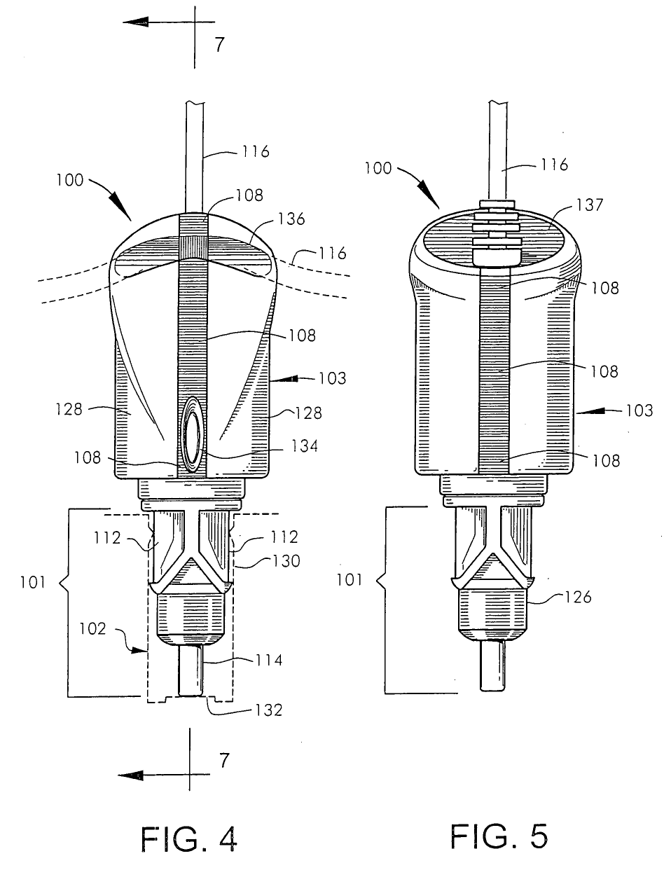

FIG. 4 is a front elevational view of in-vehicle accessory system 100, according to the preferred embodiment of FIG. 1. A typical accessory power socket 102 (illustrated using dashed lines) consists of a hollow, cylindrically-shaped, grounded contact 130 and a positive supply contact 132, as shown. Preferably, socket-engaging portion 101 of in-vehicle accessory system 100 is adapted such that, when engaged within accessory power socket 102, negative ground terminal(s) 112 contacts and forms an electrical connection with grounded contact 130, as shown. Similarly, positive terminal 114 contacts and forms an electrical connection with positive supply contact 132, as shown. Negative ground terminal(s) 112 are preferably constructed from a resilient spring steel to assist in maintaining an electrical connection with grounded contact 130, as well as to firmly retain socket-engaging portion 101, by friction, within accessory power socket 102, as shown.

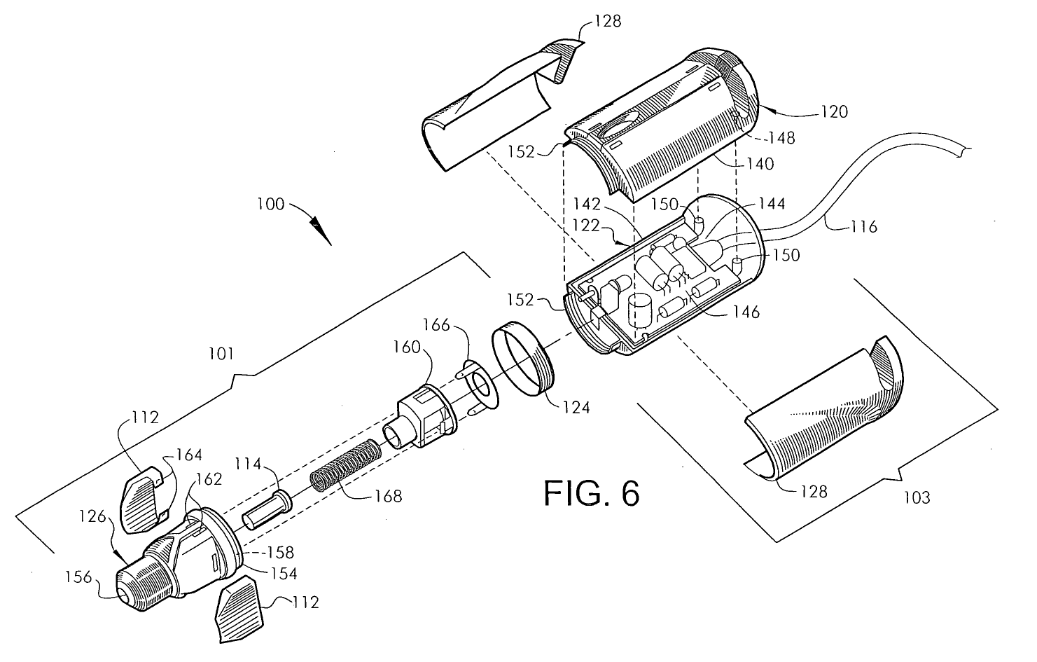

Preferably, translucent lens 134, a modified portion of upper housing 120 (see FIG. 6 and FIG. 8), is adapted to provide brightly focused illumination to indicate the presence of power in higher ambient lighting conditions (such as, for example, daylight).

Additionally, FIG. 4 illustrates the top-to-bottom extension of illuminated translucent portions 108 along graspable portion 103 of in-vehicle accessory system 100, as shown.

Preferably, cord retainer 136 (consisting of a semi-circular slot) is molded into graspable portion 103 to allow accessory cord 116 (shown using dashed lines) to be inserted and retained in stowed position when not in use (herein embodying retaining means for retaining at least one accessory cord in at least one stowed position).

FIG. 5 is a rear elevational view of in-vehicle accessory system 100, according to the preferred embodiment of FIG. 1. Visible in FIG. 5 is illuminated translucent end 137 adapted to further assist the user in quickly identifying the physical configuration of in-vehicle accessory system 100. Preferably, a top-to-bottom extension of illuminated translucent portions 108 along graspable portion 103 is also applied to the rear elevation of in-vehicle accessory system 100, as shown.

In-vehicle accessory system 100 has a preferred overall length of about 4″ and a maximum width at graspable portion 103 of about 1⅜″. Terminal receiver 126 of socket-engaging portion 101 has a maximum preferred outer diameter designed to allow for smooth insertion and frictional retention within accessory power socket 102 (a standard 12-volt vehicular accessory power socket typically has an interior diameter of about ¾″). Upon reading this specification it will be understood by those of skill in the art that under appropriate circumstances, such as international power socket standards, other applications, etc., other shapes and diameters, such as ½-inch, 10-millimeter, rectangular, etc., may suffice.

FIG. 6 is an exploded view of in-vehicle accessory system 100, according to the preferred embodiment of FIG. 1. Preferably, upper housing 120 and lower housing 122 are adapted such that, when in-vehicle accessory system 100 is assembled, the peripheral edge 140 of the upper housing 120 and the peripheral edge 142 of lower housing 122 are interlocked. Additionally, in the assembled position, a hollow interior compartment 144 within graspable portion 103 is defined for holding circuit board 146, as shown. Preferably, posts 148 and sockets 150 are integrally formed into upper housing 120 and lower housing 122 to retain the assembled housings in proper position. Under appropriate circumstances, other integrally-formed structures may be used to provide support and retention for components, such as accessory cord 116, circuit board 146, etc. Both upper housing 120 and lower housing 122 comprise one-half of an internally-threaded receiving flange 152 that, when assembled, accepts externally-threaded flange 154 of terminal receiver 126, as shown. Preferably, retention ring 124 is friction-fit over internally-threaded receiving flange 152 to further retain and position upper housing 120 and lower housing 122. Graspable portion 103 is preferably assembled by inserting circuit board 146 and accessory cord 116 into lower housing 122 prior to fitting upper housing 120 and opaque cover(s) 128.

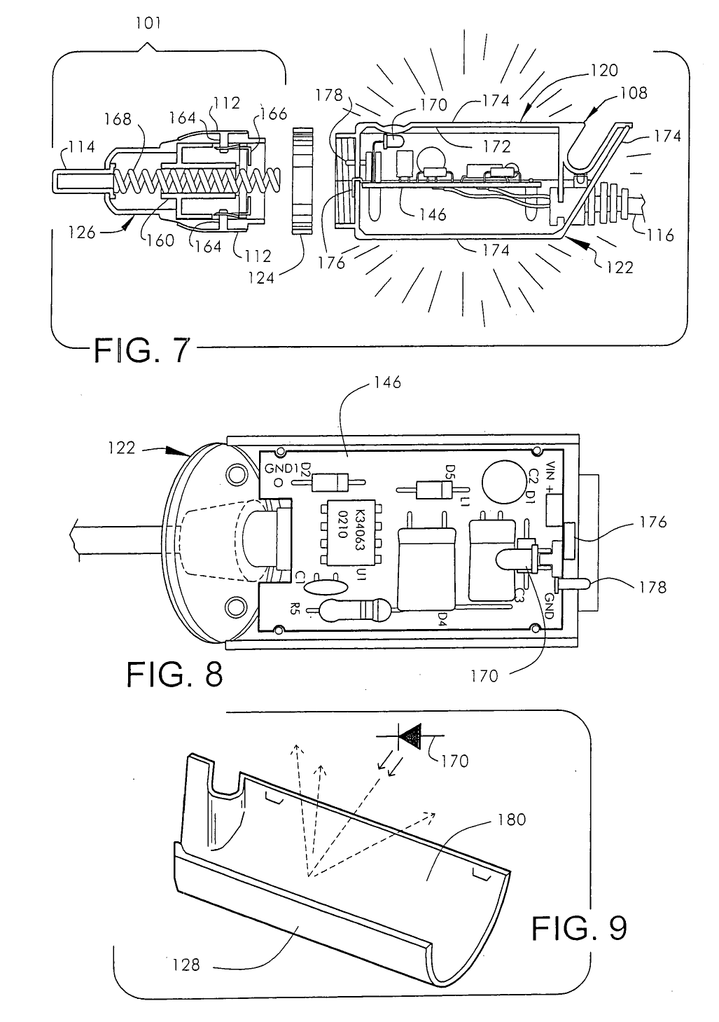

Preferably, terminal receiver 126 is a hollow, essentially cylindrical casting having first end aperture 156 to receive positive terminal 114, and a larger diameter second end aperture 158 configured to accommodate terminal retainer 160. To assemble socket-engaging portion 101, positive terminal 114 is inserted into terminal receiver 126, and is passed through first end aperture 156. Terminal retainer 160 is passed through second end aperture 158 and is internally-positioned within terminal receiver 126. Perforations 162 through terminal receiver 126 allow tab ends 164 of negative ground terminal(s) 112 to snap-engage terminal retainer 160 (see also FIG. 7). Preferably, ground terminal ring 166 similarly locks into and is retained by terminal retainer 160. Preferably, spring conductor 168 is passed through the center of ground terminal ring 166 and terminal retainer 160 to contact positive terminal 114. The assembled socket-engaging portion 101 may then be threaded to graspable portion 103 to complete in-vehicle accessory system 100.

Preferably, translucent portions 108 of exterior housing 104 may be constructed from one or more suitable translucent materials; however, for economy and ease of fabrication, all translucent components are preferably constructed from the same material, preferably a translucent, rigid, and injection-moldable thermoplastic, preferably, general-purpose polystyrene (such as “Styron 668” as manufactured by Dow Plastics, USA). Any preferred color may be applied to translucent portions 108 by coating, mixing or blending the material-forming translucent portions 108 with a pigment and/or dye, or under appropriate circumstances, by other compatible methods. It is preferred that a single plastic resin be used in the fabrication of translucent portions 108, in order to reduce production costs. Upon reading this specification it will be understood by those of skill in the art that under appropriate circumstances, such as cost considerations, alternate uses, advances in technology, etc., other translucent plastics, such as multiple materials, copolymers, thermo set plastics, mixtures, etc., may suffice.

Preferably, opaque cover(s) 128 are similarly constructed from opaque, rigid, and injection-moldable thermoplastic, preferably, general-purpose polystyrene (such as “Styron 668” as manufactured by Dow Plastics, USA). Upon reading this specification it will be understood by those of skill in the art that under appropriate circumstances, such as cost considerations, alternate uses, advances in technology, etc., other materials, such as multiple materials, copolymers, thermo set plastics, mixtures, etc., may suffice. Any preferred color may be applied to opaque cover(s) 128 by coating, mixing or blending the material-forming opaque cover(s) 128 with a pigment, paint and/or dye. Under appropriate circumstances, an opaque coating may be applied directly to translucent portions 108 (in lieu of the use of a separate opaque cover 128). Unless noted otherwise, all electrically-conductive materials described herein are preferably metallic in composition.

FIG. 7 is the sectional view 7-7 of FIG. 4, according to the preferred embodiment of FIG. 1. Light Emitting Diode 170 (hereafter referred to as LED 170) preferably originates on circuit board 146, as shown. LED 170 (herein embodying illumination means within such translucent housing means for indicating presence of power) is preferably a high-intensity-type, preferably emitting a color matching the color of translucent portions 108. Preferably, LED 170 is positioned directly below the interior surface 172 of upper housing 120, as shown (under appropriate circumstances, other positions of LED 170 may be used; for example, to highlight a specific feature of in-vehicle accessory system 100). Preferably, a light-diffusing texture 174 is integrally formed to the exterior surfaces of translucent portions 108 (herein embodying light diffusion means for diffusing the light of such illumination means along substantially an entire length of such translucent housing means). The preferred light diffusing texture 174 consists of one or more mold-formed surface finishes that facilitate diffusion of light from LED 170 throughout the translucent component, as shown. Under appropriate circumstances, an applied surface coating, or a diffusing compound added to the matrix of the translucent material, may be used to generate diffusion of the light throughout translucent portions 108 (herein embodying wherein such at least one light diffuser comprises at least one surface texture applied to such at least one translucent housing; wherein such at least one light diffuser comprises at least one light-diffusing compound integrally formed within such at least one translucent housing; and wherein such at least one light diffuser comprises at least one surface coating applied to such at least one translucent housing). Under appropriate circumstances, “translucent” may also include the term “transparent”, such that at least one portion of the housing material is sufficiently light-permeable to permit viewing of the internal contents of in-vehicle accessory system 100.

Preferably, tab ends 164 of negative ground terminal(s) 112 are in direct contact with ground terminal ring 166 when both are engaged on terminal retainer 160, as shown. Preferably, terminal retainer 160 is plastic, acting as an insulator to isolate all positive and negative terminals, as shown. Power originating at positive terminal 114 is conducted along the length of spring conductor 168. Further, spring conductor 168 allows positive terminal 114 to move longitudinally along the center axis of socket-engaging portion 101, thereby assuring firm contact between positive terminal 114 and positive supply contact 132 (see FIG. 4).

Preferably, circuit board 146 includes positive contact plate 176 and neutral contact pin 178, as shown. When socket-engaging portion 101 is threaded to graspable portion 103, positive contact plate 176 contacts spring conductor 168, while neutral contact pin 178 simultaneously contacts ground terminal ring 166, thereby forming a continuous path for electrical power between positive terminal 114 and circuit board 146, and negative ground terminal(s) 112 and circuit board 146.

FIG. 8 is a depiction of circuit board 146 and lower housing 122 of in-vehicle accessory system 100, according to the preferred embodiment of FIG. 1. Preferably, circuit board 146 functions as a power control interface between the vehicle power source (at accessory power socket 102) and the accessory served by in-vehicle accessory system 100. Upon reading this specification it will be understood by those of skill in the art that under appropriate circumstances, such as foreign power standards, alternate uses, availability of parts, etc., other circuit board configurations may suffice.

FIG. 9 is a perspective view, illustrating the reflective features of the outer opaque cover 128 of in-vehicle accessory system 100, according to the preferred embodiment of FIG. 1. Preferably, opaque cover(s) 128 are constructed from a material having a reflective quality (herein embodying at least one reflecting means for internally-reflecting the light from such illumination means and such light diffusion means, and herein embodying wherein such at least one light blocker comprises at least one reflector structured and arranged to internally reflect the light from such at least one illuminator). By internally reflecting the light produced by LED 170 (and further carried by the diffusion of light throughout translucent portions 108), a highly-preferred degree of light transmission is achieved. In the preferred embodiment of FIG. 9, the interior surface 180 of opaque cover 128 is integrally-colored white. Upon reading this specification it will be understood by those of skill in the art that under appropriate circumstances, such as user preference, availability of materials, etc., other other colors and finishes, such as silver or similar metallic finishes, may suffice. As can be seen in FIG. 9, the shape of opaque cover 128 is such that it precisely conforms to the outer surface shape of upper housing 120 and lower housing 122 (which, when assembled, form an essentially circular annulus shape, as shown).

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

What is claimed is:

1) A vehicle accessory system for use with at least one plug-in accessory outlet comprising:
a) translucent housing means for housing a vehicle plug-in accessory for use with the at least one plug-in accessory outlet;
b) illumination means within said translucent housing means for indicating presence of power;
c) wherein said translucent housing means comprises light diffusion means for diffusing the light of said illumination means along substantially an entire length of said translucent housing means.

2) The vehicle accessory system according to claim 1 wherein said system further comprises light-blocking means for locally blocking a substantial exit of the light from said translucent housing means.

3) The vehicle accessory system according to claim 2 wherein said light-blocking means comprises at least one reflecting means for internally reflecting the light from said illumination means and said light diffusion means.

4) The vehicle accessory system according to claim 1 wherein:
a) said light blocking means further comprises aperture means; and
b) said aperture means comprises indicia means illuminated by said illumination means and said light diffusion means.

5) The vehicle accessory system according to claim 3 wherein said light-blocking means further comprises retaining means for retaining at least one accessory cord in at least one stowed position.

6) A vehicle accessory system for use with at least one plug-in accessory outlet comprising:
a) at least one translucent housing structured and arranged to house a vehicle plug-in accessory for use with the at least one plug-in accessory outlet;
b) at least one illuminator, within said at least one translucent housing, structured and arranged to indicate presence of power;
c) wherein said at least one translucent housing comprises at least one light diffuser for diffusing the light of said at least one illuminator along substantially an entire length of said at least one translucent housing.

7) The vehicle accessory system according to claim 6 wherein said system further comprises at least one light blocker structured and arranged to locally block a substantial exit of the light from said at least one translucent housing.

8) The vehicle accessory system according to claim 7 wherein said at least one illuminator comprises at least one light-emitting diode.

9) The vehicle accessory system according to claim 8 wherein said at least one light blocker comprises aperture portions comprising indicia illuminated by said at least one illuminator and said at least one light diffuser.

10) The vehicle accessory system according to claim 6 wherein the shape of said translucent housing means comprises at least one portion of an essentially circular annulus.

11) The vehicle accessory system according to claim 7 wherein said at least one light blocker comprises:
a) at least one element attachable with said housing; and
b) at least one reflector structured and arranged to internally reflect the light from said at least one illuminator.

12) The vehicle accessory system according to claim 11 wherein said at least one light blocker further comprises at least one retainer structured and arranged to retain at least one accessory cord in at least one stowed position.

13) The vehicle accessory system according to claim 6 wherein said at least one translucent housing comprises at least one rigid moldable material.

14) The vehicle accessory system according to claim 6 wherein said at least one light diffuser comprises at least one surface texture applied to said at least one translucent housing.

15) The vehicle accessory system according to claim 6 wherein said at least one light diffuser comprises at least one light diffusing compound integrally formed within said at least one translucent housing.

16) The vehicle accessory system according to claim 6 wherein said at least one light diffuser comprises at least one surface coating applied to said at least one translucent housing.

17) The vehicle accessory system according to claim 7 wherein said at least one light blocker comprises an essentially opaque outer cover structured and arranged to be attachable with said at least one translucent housing.

18) The vehicle accessory system according to claim 7 wherein said at least one light blocker comprises an essentially opaque coating applied to said at least one translucent housing.

19) The vehicle accessory system according to claim 7 wherein said at least one translucent housing comprises at least one portion sufficiently transparent to provide an indication of an internal content of said at least one translucent housing from outside said at least one translucent housing.

20) A vehicle accessory system, for providing increased safety for a vehicle driver in low ambient-light conditions, comprising:
b) at least one vehicle comprising at least one-plug-in accessory outlet within view of the driver;
c) at least one translucent housing structured and arranged to house a vehicle plug-in accessory for use with said at least one plug-in accessory outlet; and
d) at least one illuminator, within said at least one translucent housing, structured and arranged to indicate presence of power;
e) wherein said at least one translucent housing comprises at least one light diffuser for diffusing the light of said at least one illuminator along substantially an entire length of said at least one translucent housing;
f) wherein said vehicle accessory system, when said at least one plug-in accessory outlet is powering said at least one illuminator, is structured and arranged to provide clear visual indication of the vehicle plug-in accessory's locational presence when in use in low ambient light conditions.
